(19) United States
(12) Patent Application Publication
(10) Pub. No.: US 2009/0189388 A1
(43) Pub. Date: Jul. 30, 2009

(54) Book holder

(76) Inventor: Manuel D. Mills, Midland, TX (US)

Correspondence Address: LOREN G. HELMREICH, 5851 San Felipe, SUITE 975, HOUSTON, TX, 77057, US

(21) Appl. No.: 12/011,687

(22) Filed: Jan. 29, 2008

(51) Int. Cl. B42D 3/16

(52) U.S. Cl. 281/45

(57) ABSTRACT

An adjustable book holder 10 includes a support plate 12 for supporting an open book, and one or more rails 30, 31 each extendable from a side of the support plate for engaging an open book having a width greater than the width of the support plate. An elastic band 32 extends from one of the rails, across the open book, and is removably engaged with the opposing rail or with an opposing side of the support plate. Suction cups 16, 28, may be used for supporting the book holder, and a flexible chain 43 may be adjusted to alter the inclination of the support plate with respect to a rear brace.

### FIELD OF THE INVENTION

The present invention relates to a book holder, and more particularly to an adjustable book holder suitable for supporting various size books each at a selected viewing angle.

### BACKGROUND OF THE INVENTION

Book holders have been devised in various types and shapes. Many book holders are limited in the size of the book that can be reliably supported on the book holder, and/or position the book at a fixed viewing angle relative to a horizontal support surface.

U.S. Pat. No. 3,981,522 discloses a book holder that discloses a page holding strap and a strut element supporting a pair of coupler panels. U.S. Pat. No. 3,948,476 discloses a music stand for use with a stringed instrument. U.S. Pat. No. 4,395,057 discloses a book holder which utilizes a variety of elastic bands and a handle. U.S. Pat. No. 4,145,022 discloses a book holder with sheet-like members having ends for engagement with a book page. U.S. Pat. No. 5,621,927 discloses a book holder and utility tray for use with a bathtub. U.S. Pat. No. 5,761,753 discloses another variety of a book holder for use by a person while bathing. U.S. Pat. No. 6,045,159 discloses a book holder with a transparent flexible plastic strap and a book slide section. U.S. Pat. No. 6,733,043 discloses a device with flexible arms for engaging the open pages of a book.

Publication 2007/0090264 discloses a complex book holding devices with beads at the end of spring loaded wires. A book rest intended for a bean bag chair is disclosed in U.S. Publication 2007/0114356.

The disadvantages of the prior art are overcome by the present invention, and an improved book holder is hereinafter disclosed.

### SUMMARY OF THE INVENTION

According to one embodiment, an adjustable book holder comprises a support plate for supporting an open book on the support plate, and may include one or more stops adjacent a lower end of the support plate for engaging a lower end of the open book. One or more rails are each extendable from the side of the support plate for supporting an open book having a width greater than a width of the support plate. An elastic band extends from one end of a rail, across the open book, and is removably engagable with one of an opposing side of the support plate and an opposing rail. A rear brace pivotally connects the support plate and has a surface engaging lower end for positioning the support plate at a selected viewing angle.

These and further features and advantages of the present invention will become apparent from the following detailed description, wherein reference is made to the figures in the accompanying drawings.

### BRIEF DESCRIPTION OF THE DRAWINGS

FIG. 1 is a front pictorial view of one embodiment of the invention.

FIG. 2 is a side view of the book holder shown in FIG. 1, with the elastic band removed for clarity.

FIG. 3 is a rear view of an alternate embodiment of the book holder.

FIG. 4 is a front view of the book holder shown in FIG. 3, with an open book positioned on the book holder.

### DETAILED DESCRIPTION OF PREFERRED EMBODIMENTS

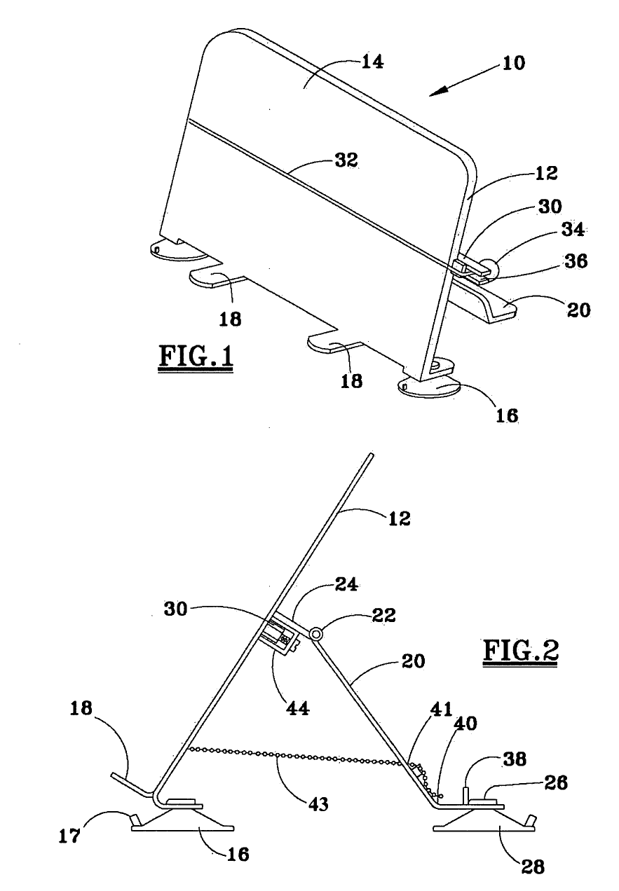

FIG. 1 depicts one embodiment of a book holder according to the present invention. As explained subsequently, the book holder is easily adjustable by the user for supporting different size books and for positioning a book at a selected angle with respect to the user. In a preferred embodiment, the book holder with this adjustable feature includes a mechanism to support an open book with a width greater than the support plate, and with an elastic band holding the book open.

FIG. 1 depicts an adjustable book holder 10 for supporting a book on a support plate 12 with front face 14. The plurality of suction cups 16 may be attached to the lower end of a plate 12, and may be used in a conventional manner to removably yet firmly secure the book holder at a desired location on a planar surface. The support plate 12 may also include a plurality of lower tabs 18, which extend opposite the rear support 20 with respect to the plate 14, and provide a floor for holding the book. In alternative embodiments, other mechanisms may be used for providing a floor for the book so that its position is vertically constant with respect to the plate 12 when in use. In still other embodiments, the planar surface to which the suction cups 16 are attached may serve as the floor for the open book.

FIGS. 1 and 2 show another feature of the book holder, namely the use of one or more rails 30 which are each extendable from a side of the support plate 12 for supporting an open book having a width greater than the width of the support plate. Support plate 12 preferably is a substantially unitary structure with a front surface 14 lying within a common plane. FIG. 1 illustrates rail 30 on one side of the plate. The lateral position of the rail with respect to the plate may be easily adjusted, as discussed subsequently. In other embodiments, a pair of rails may be provided, as disclosed subsequently, each extendable from a respective side of the support plate, such that each rail engages a side edge of the open book when positioned on the support plate.

An elastic band 32 extends from one side of a plate 12, across the plate, and to the rail 30. This elastic band 32 exerts a slight pressure on the open book pages to keep the book in the open position. A relatively thin cord or strap may be used for the elastic band 32, and if a strap is used, the strap may be transparent. Stop member 34 at the end of the cord 32 thus retains the cord in the slot 36 in the rail 30, and allows the cord to be easily detached from a rail and reattached to the rail, e.g., for changing pages of the book. In other embodiments, the flexible band 32 may be sufficiently elastic that the user can exert a pulling pressure on the strap sufficient to lift the strap from the pages so that the user may turn the page with the other hand, then return the strap to the open book pages.

As shown in FIG. 2, a rear brace 20 is pivotally connected at 22 to bracket 24, which is secured to support plate 12. As shown in FIG. 2, the rear brace 20 has a surface engaging lower end 26 for positioning the support plate at a selected viewing angle. The lower end of the rear brace 20 may be temporarily fixed in position by another suction cup 28, and both the suction cups 16 and the suction cup 28 may operate in the same common plane. Each of the suction cups may also include a release tab 17, as shown in FIG. 2, for facilitating the release of the suction by the user.

FIG. 2 also illustrates one of more tabs 38 at the lower end of the rear brace 20 for effectively providing a cavity 40 between the inclined portion of the support plate and the lower end of the support plate, so that the cavity 40 may be used for receiving a pen or other writing instrument.

A flexible chain 43 extends between the support plate 12 and the rear brace 20, and the length of the chain relative to chain catch 41 may be adjusted so that the effective angle of the support plate 12 may be achieved. Chain 43 need not be used in all applications since the suction cups may position the support plate 12 at a desired angle. If the book holder is set on an uneven surface where the suction cups are not operable, the chain 43 may be used instead of the cups to position the plate 12 at a desired angle.

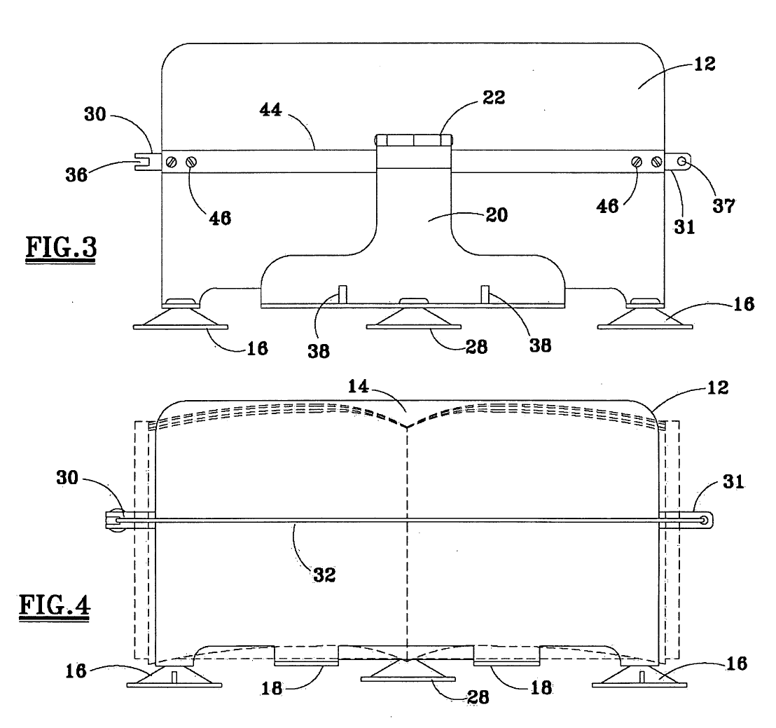

As shown in FIG. 2, and more clearly in FIG. 3, elongate guide member 44 is secured to the support plate 12, and has a cavity for receiving one or both of the rails 30. Also, a conventional screw or other locking member 46 may be used for locking the lateral position of a rail with respect to the support plate allowing for the release of the locking mechanism to change this lateral position, then relock the rail in the new position. The rail 30 as shown in FIG. 3 includes the slot 36 for receiving the elastic band. An opposing rail 31 is also shown in FIG. 3, and may include a similar slot or alternatively simply a hole 37 in the rail, since only one end of the elastic band need be easily removed from a rail, as explained above. Each rail 30 and 31 may thus move laterally with respect to the plate 12, and this lateral movement is preferably independent from the movement of the other rail. FIG. 3 also illustrates that the lower end of the rear brace has a substantial width preferably greater than one-half of the width of plate 12. This allows for tabs 38 to be desirably spaced apart, and also allows the book holder to be supported on the legs or lap of the user while seated.

FIG. 4 shows a book in dashed lines positioned on a plate 12, with rails 30 and 31 extended to support the sides of the book which extend beyond the support plate. If two rails are provided, as shown in FIG. 4, the elastic band preferably extends from one rail, across the open book, and to the opposing rail. Since a book only slightly wider than the plate 12 is shown in FIG. 4, the rails 30, 31 are only slightly extended. For a wider book, the rails would thus extend laterally further for the plate 12.

The book holder as disclosed herein may be used for holding a variety of papers other than books. For example, the book holder may be positioned on the dash of an RV vehicle to hold maps, or may be used in the kitchen to hold a plurality of recipe sheets. Nursing stations and typists may use the book holder to organize and support papers, and to more easily in view papers while at a work station. The term “book” as used herein is broadly intended to include any compilation of pages with writing or markings thereon.

While preferred embodiments of the present invention have been illustrated in detail, it is apparent that modification and adaptations of the preferred embodiments will occur to those skilled in the art. However, it is to be expressly understood that such modifications and adaptations are within the spirit and scope of the present invention as set forth in the following claims.

What is claimed is:

1. An adjustable book holder, comprising:
a support plate for supporting an opened book on the support plate;
one or more rails each extendable from a side of the support plate for supporting an open book having a width greater than a width of the support plate; and
an elastic band extending from an end of the one or more rails, across the open book, and removably engagable with one of an opposing side of the support plate and an opposing rail.

2. A book holder as defined in claim 1, wherein the support plate is substantially a unitary structure with a front surface lying substantially within a common plane.

3. A book holder as defined in claim 1, wherein the one or more rails include a pair of rails each extendable from a respective side of the support plate, such that each rail engages a side edge of the opened book when positioned on the support plate.

4. A book holder as defined in claim 1, further comprising:
a rear brace pivotally connected to the support plate and having a surface engaging lower end for positioning the support plate at a selected viewing angle.

5. A book holder as defined in claim 4, wherein an angular position of the rear brace relative to the support plate may be selectively adjusted.

6. A book holder as defined in claim 4, wherein the support plate is supported on a pair of suction cups, and the rear brace is supported on another suction cup.

7. A book holder as defined in claim 4, further comprising:
a selectively adjustable flexible chain for acting between the support plate and the rear brace.

8. A book holder as defined in claim 1, further comprising:
one or more stops adjacent a lower end of the support plate for engaging a lower edge of the opened book.

9. An adjustable book holder, comprising:
a support plate for supporting an opened book on the support plate;
one or more rails each extendable from a side of the support plate for supporting an open book having a width greater than a width of the support plate;
an elastic band extending from an end of the one or more rails, across the open book, and removably engagable with one of an opposing side of the support plate and an opposing rail;
a rear brace pivotally connected to the support plate and having a surface engaging lower end for positioning the support plate at a selected viewing angle by adjusting an angular position of the rear brace relative to the support plate; and
the support plate is supported on a pair of suction cups.

10. A book holder as defined in claim 9, wherein the one or more rails include a pair of rails each extendable from a respective side of the support plate, such that each rail engages a side edge of the opened book when positioned on the support plate.

11. A book holder as defined in claim 9, further comprising:
a selectively adjustable flexible chain for acting between the support plate and the rear brace.

12. A book holder as defined in claim 9, wherein the support plate is substantially a unitary structure with a front surface lying substantially within a common plane.

13. A book holder as defined in claim 9, wherein the rear brace is supported on another suction cup.

14. A book holder as defined in claim 9, further comprising:
one or more stops adjacent a lower end of the support plate for engaging a lower edge of the opened book.

15. An adjustable book holder, comprising:
a support plate for supporting an opened book on the support plate, the support plate being a substantially a unitary structure with a front surface lying substantially within a common plane;
a pair of rails each extendable from a respective side of the support plate for supporting an open book having a width greater than a width of the support plate; and
an elastic band extending from an end of one rail, across the open book, and removably engagable with an opposing rail.

16. A book holder as defined in claim 15, further comprising:
one or more stops adjacent a lower end of the support plate for engaging a lower edge of the opened book.

17. A book holder as defined in claim 15, further comprising:
a rear brace pivotally connected to the support plate and having a surface engaging lower end for positioning the support plate at a selected angle.

18. A book holder as defined in claim 17, wherein the rear brace is supported on another suction cup.

19. A book holder as defined in claim 15, wherein the support plate is supported on a pair of suction cups.

20. A book holder as defined in claim 15, further comprising:
a selectively adjustable flexible chain for acting between the support plate and the rear brace.
